(19) United States
(12) Patent Application Publication
(10) Pub. No.: US 2022/0276107 A1
(43) Pub. Date: Sep. 1, 2022

(54) LOAD TORQUE DETECTION DEVICE AND METHOD

(71) Applicant: ROBOTIS CO., LTD., Seoul (KR)

(72) Inventors: Byoung Soo KIM, Seoul (KR); In Yong HA, Seoul (KR); Yong Hee JEON, Seoul (KR); Soo Kyung SON, Gyeonggi-do (KR); Hyoung Chul NAM, Seoul (KR)

(73) Assignee: ROBOTIS CO., LTD., Seoul (KR)

(21) Appl. No.: 17/749,242

(22) Filed: May 20, 2022

Related U.S. Application Data
(63) Continuation of application No. PCT/KR2019/016287, filed on Nov. 25, 2019.

(30) Foreign Application Priority Data
Nov. 21, 2019 (KR) 10-2019-0150559

(51) Int. Cl. G01L 5/00; G01L 3/04; G01L 1/04; G01L 5/22; G01L 3/08; G01L 3/10

(52) U.S. Cl. CPC G01L 5/0042; G01L 3/04; G01L 1/048; G01L 5/226; G01L 3/08; G01L 3/101

(57) ABSTRACT

The present invention relates to a load torque detection technology, and more particularly, to a device and method for load torque detection in a robot system. According to an embodiment of the present invention, it is possible to accurately detect the load torque without requiring a position sensor included in a load torque measurement actuator to have a multi-revolution function or additional power supply.

### CROSS-REFERENCE TO RELATED APPLICATION

This application is a continuation of International Application No. PCT/KR2019/016287 filed on Nov. 25, 2019, which claims priority to Korean Patent Application No. 10-2019-0150559 filed on Nov. 21, 2019, the entire contents of which are herein incorporated by reference.

### TECHNICAL FIELD

The present invention relates to a load torque detection technology, and more particularly, to a device and method for load torque detection.

### BACKGROUND

In the aspect of robot system driving and safety, measuring a torque in each joint link of a robot is very important. The torque of an actuator refers to a force generated by the joints of the robot, and the entire robot can be controlled more quickly and stably through correct measurement of the force of each joint and appropriate feedbacks thereto. In addition, by detecting an unexpected external shock or load, it is possible to protect a user from a physical collision with a drive system or prevent deterioration of the system durability such as damage to the drive shaft and the like.

The background art of the present disclosure is disclosed in Korean Patent Laid-open No. 10-2005-0009001.

### SUMMARY

The present invention provides a load torque detection device and method for accurately detecting a load torque by compensating for an error in multi-revolution information generated by distortion information of an elastic body.

According to one aspect of the present invention, a load torque detection device is provided. According to an embodiment of the present disclosure, the load torque detection device may include a load torque measurement actuator comprising a first position sensor, an elastic body, a reducer, a second position sensor, and a motor assembled in series to a load link, and generating information for measuring a torque of the load link by using a torsion of the elastic body, and a load torque detection unit that indexes an output of the first position connected to the load link to utilize multi-revolution information of the second position sensor connected to a shaft of motor, and compensates an indexing error that may occur due to the torsion of the elastic body and a backlash of the reducer to detect the torque of the load link.

According to another aspect of the present invention, there may be provided a load torque detection method and a computer-readable recording medium recording a computer program executing the method. According to an embodiment of the present disclosure, the load torque detection method and the computer-readable recording medium may include calculating an indexing value for calculating a multi-revolution factor and the multi-revolution factor, by using a first rotational position value of a first position sensor and a reduction ratio, calculating a strain output by a backlash and an elastic body by subtracting a single-revolution factor including an error from a second rotational position value of a second position sensor, calculating a multi-revolution value of the motor that is error-compensated based on the second rotational position value of the second position sensor and the strain output by the backlash and the elastic body, calculating a compensated rotational position value of the motor by summing the second rotational position value of the second position sensor and the multi-revolution factor that is error-compensated, calculating the strain output by the elastic body by using the first rotational position value and the reduction ratio of the first position sensor, the strain output by the backlash, and the compensated rotational position value of the motor, and calculating a torque of a load link by using the strain output by the backlash, the strain output by the elastic body, and a spring coefficient.

According to an embodiment of the present invention, it is possible to accurately detect the load torque without requiring a position sensor included in a load torque measurement actuator to have a multi-revolution function or additional power supply.

### BRIEF DESCRIPTION OF THE DRAWINGS

FIGS. 1 to 6 are diagrams for explaining a load torque detection device according to an embodiment of the present invention.

FIGS. 7 to 10 are diagrams for explaining a load torque detection method according to an embodiment of the present invention.

### DETAILED DESCRIPTION

Since the present disclosure can have various modifications and various embodiments, certain embodiments are illustrated in the drawings by way of examples and will be described in detail through detailed description. However, it should be understood that the disclosure is not to be limited to specific embodiments, but includes all modifications, equivalents, and alternatives falling within the spirit and scope of the disclosure. In describing the present disclosure, when it is determined that a detailed description of a related known technology may unnecessarily obscure the gist of the present disclosure, the detailed description thereof will be omitted. In addition, a singular expression used in the description and the claims should generally be construed to mean “one or more” unless stated otherwise.

Hereinafter, preferred embodiments of the present disclosure will be described in detail with reference to the accompanying drawings, and while describing the embodiments with reference to the accompanying drawings, the same or corresponding components are given the same reference numerals, and redundant descriptions thereof will be omitted.

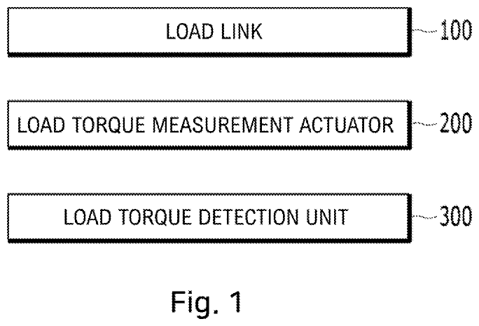

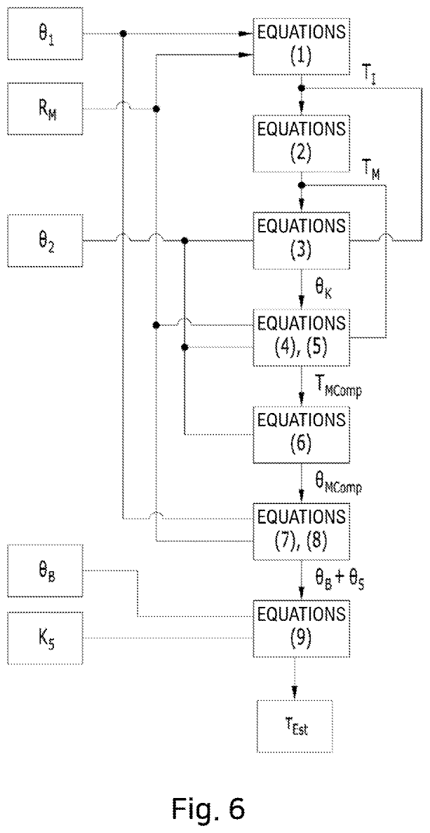

FIGS. 1 to 6 are diagrams for explaining a load torque detection device according to an embodiment of the present invention.

Referring to FIG. 1, the load torque detection device includes a load link 100, a load torque measurement actuator 200, and a load torque detection unit 300.

The load link 100 is in a state constrained by a link connected to the load.

The load torque measurement actuator 200 includes a first position sensor, an elastic body, a reducer, a second position sensor, and a motor assembled in series to the load link, and generates information for measuring a torque of the load link by using a torsion of the elastic body.

The load torque detection unit indexes an output of a first position sensor 210 connected to the load link to utilize this as multi-revolution information of a second position sensor 240 connected to the motor shaft, and compensates for an indexing error that may occur due to the torsion of the elastic body and a backlash of the reducer to thus detect the torque of the load link. The load torque detection unit 300 may detect the load torque by calculating the absolute position of the motor shaft using the information generated by the load torque measurement actuator 200 to which the absolute position sensor is attached, without itself having a multi-revolution function or additional power supply of the position sensor.

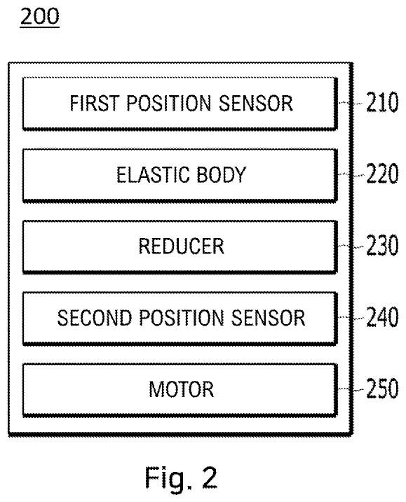

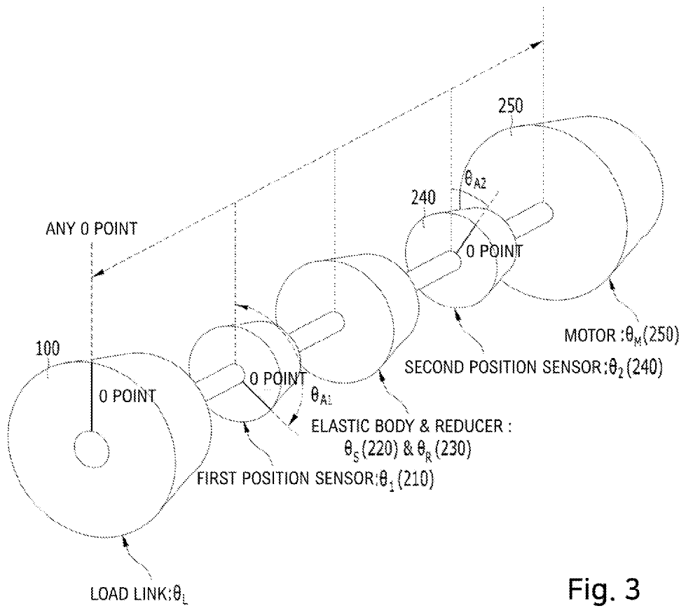

Referring to FIGS. 2 and 3, the load torque measurement actuator 200 includes the first position sensor 210, an elastic body 220, a reducer 230, the second position sensor 240, and a motor 250.

The first position sensor 210 is positioned between the load link 100 and the elastic body 220 to measure a rotational position value of the load link 100. The first position sensor 210 is an absolute position sensor such as an optical or magnetic encoder or resolver, for example. In addition, the first position sensor 210 may be a rotation type or a linear type.

The elastic body 220 measures a force (torque) applied to both ends of the elastic body by the degree of distortion of both ends. When the first position sensor 210 and the second position sensor 240 are directly attached to both ends of the elastic body 220, it may be possible to simply compare the outputs of the two position sensors and multiply by a spring coefficient to detect the applied torque.

The reducer 230 reduces the rotational force of the motor according to a preset reduction ratio. The reducer 230 reduces the rotational force such that, even when the rotational force of the motor is increased beyond a certain level at which exceeding one rotation is possible, the load link 100 does not exceed one rotation under the influence of the speed reduction.

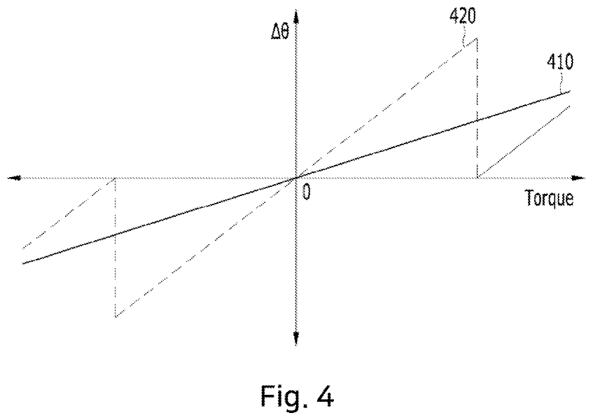

Referring to FIG. 4, when the rotational force of the motor increases beyond the certain level thus resulting in exceeding one rotation, an output 420 of the second position sensor 240 increases from 0 again, and a displacement 410 of the first position sensor 210 and a displacement 420 of the second position sensor 240 also increase again, resulting in an error that the measured torque value also increases from 0 again. Therefore, in order to detect the torque in a situation in which the maximum output range of the second position sensor 240 is exceeded, the multi-revolution information has to be known. In general, the microcontroller (MCU) receives the output of the position sensor and calculates the physical position, but when the power is turned off and on or the microcontroller is rebooted for various other reasons, the previously calculated position data is lost. Therefore, in applications where the calculation of the multi-revolutions of the position sensor is required, the position sensor has a structure capable of outputting the multi-revolutions by itself or has an additional power source or battery separate from the main power supply to continuously calculate the position even when the main power is cut off. However, the position sensor that outputs the multi-revolutions by itself has a problem in that it makes the structure complicated or bulky, and the position sensor having a battery has the inconvenience in that it is necessary to periodically replace the battery.

The second position sensor 240 measures a rotational position value of the motor 250. Like the first position sensor 210, the second position sensor 240 is an absolute position sensor such as, for example, an optical or magnetic encoder or resolver. In addition, the second position sensor 240 may be a rotation type or a linear type.

The motor 250 provides rotational driving force.

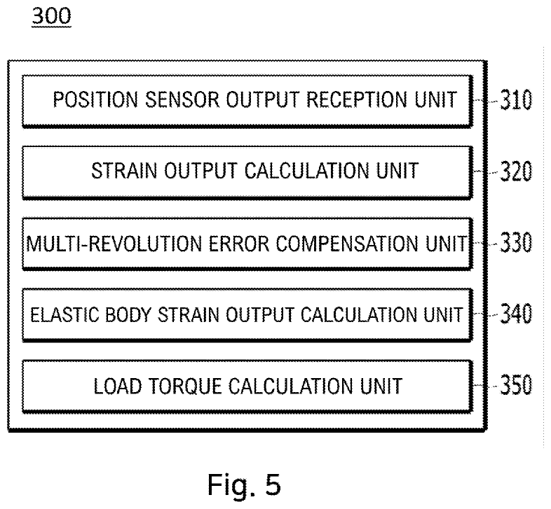

Referring to FIG. 5, the load torque detection unit 300 includes a position sensor output reception unit 310, a strain output calculation unit 320, a multi-revolution error compensation unit 330, an elastic body strain output calculation unit 340, and a load torque calculation unit 350.

The position sensor output reception unit 310 receives a first rotational position value and a second rotational position value from the first position sensor 210 and the second position sensor 240.

The first position sensor 210 and the second position sensor 240 are rotary sensors, and may express an angle (position) of 0 to 360[°] as a unit of rotation, and have a rotational position value as a positive value between 0 and 1.

When the reduction ratio of the reducer 230 is an integer and the calculable multi-revolutions of the motor shaft is limited within the range of the reduction ratio, the absolute position of the motor shaft may be calculated by the following equations.

TI=θ1*RM [Equation 1]

TM=[TI] [Equation 2]

where, θ1 is a rotational position value of the first position sensor, RM is a reduction ratio of the reducer, TI is an indexing value for calculating the multi-revolutions, and TM is the calculated multi-revolution position value of the second position sensor.

The strain output calculation unit 320 calculates the strain output (θK) by the backlash and the elastic body by using the first rotational position value, the second rotational position value, and the preset reduction ratio.

θK=θ2−TS [Equation 3]

where, θ2 is the rotational position value of the second position sensor, θK is the strain by the backlash and the elastic body, TS is the single revolution including error, calculated by TI−TM by taking only the fractional part of TI.

The multi-revolution error compensation unit 330 compensates for a multi-revolution error generated by the strain caused by the backlash and the elastic body to calculate a compensated multi-revolution value of the motor and a compensated rotational position value of the motor. Here, when the deformable range (θK) by the backlash and the elastic body is physically limited to within one revolution of the primary side of the reducer at the time of calculation, since TI has an error within ±0.5 based on single revolution (θ2), compensation for the calculation of multi-revolutions is possible with the following equation.

TMcomp=([TI]−1)mod RM,0.5≤θK<1 and 0.55≤θ2<1 [Equation 4]

TMcomp=([TI]+1)mod RM,−1≤θK<−0.5 and 0≤θ2<0.5 [Equation 5]

where, TMcomp is the multi-revolution value of the motor after error compensation.

θMcomp=TMcomp+92 [Equation 6]

where, θMcomp is the rotational position value of the motor after error compensation.

The elastic body strain output calculation unit 340 calculates an output of the elastic body strain using the multi-revolution value of the motor and the rotational position value of the motor after multi-revolution error compensation.

θB+θS=(1+θ1)−θMcomp/RM (when IT=0 and TMcomp=RM−1) [Equation 7]

θB+θS=θ1−∂Mcomp/RM (otherwise) [Equation 8]

where, a discontinuity occurs in the value of θ1 in a section of exceeding one rotation of the load shaft, and substituting into the corresponding equation as it is in the condition of TI=0 and TMcomp=RM−1 will result in a large error in the calculation. Therefore, 1 should be added to θ1 to avoid this problem.

The load torque calculation unit 350 calculates the load torque by using the strain output by the elastic body, the spring coefficient, and the strain output by backlash.

By the spring equation of motion,

τEst=θB+KS*θS [Equation 9]

where, τEst is the load torque detected by the spring, in the unit of [Nm], KS is the spring coefficient (stiffness) of the elastic body, in the unit of [Nm/revolution], and θB is the intrinsic value of the strain output by backlash.

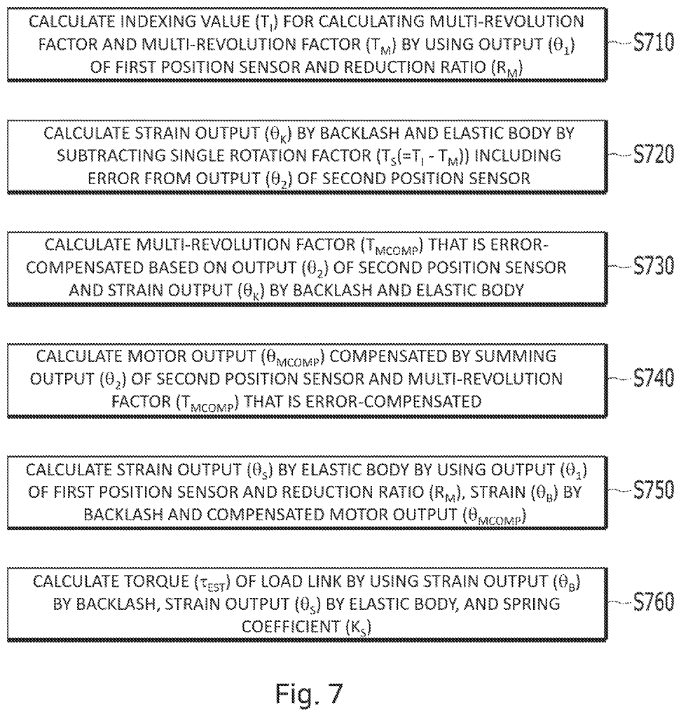

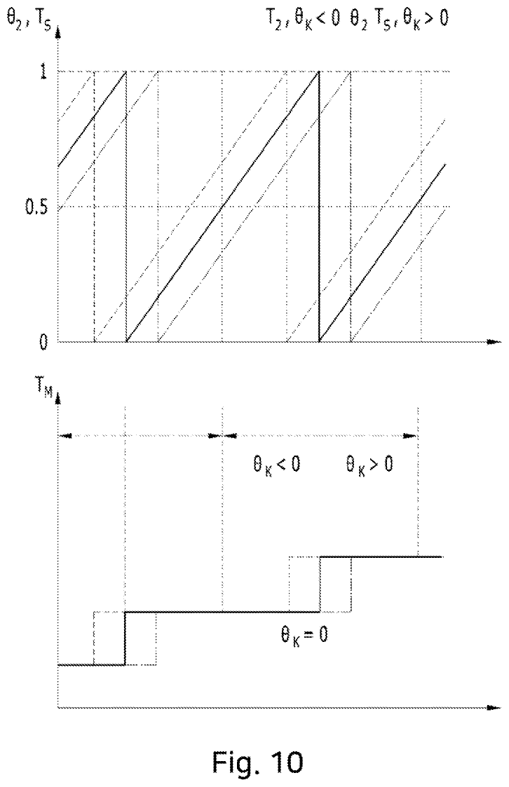

FIGS. 7 to 10 are diagrams for explaining a load torque detection method according to an embodiment of the present invention.

Referring to FIG. 7, in step S710, the load torque detection device calculates an indexing value TI for calculating a multi-revolution factor, and the multi-revolution factor TM, by using the first rotational position value θ1 and the reduction ratio RM of the first position sensor. Specifically, the load torque detection device may calculate the indexing value TI and the multi-revolution factor TM by using Equations (1) and (2) described above.

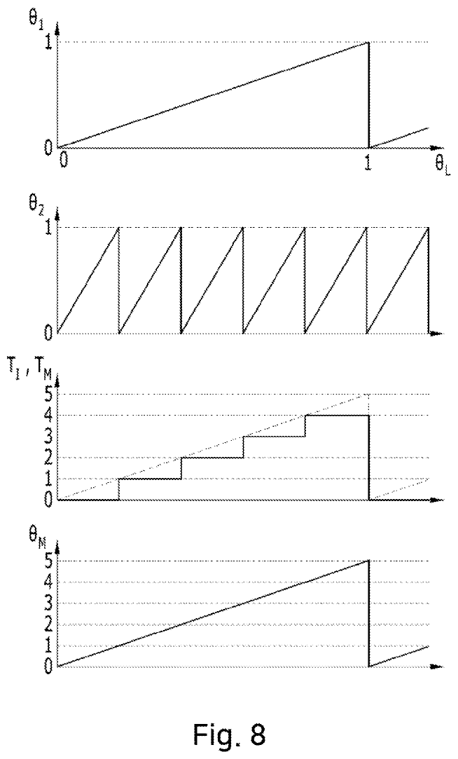

Referring to FIG. 8, the first rotational position value θ1 of the first position sensor and the second rotational position value θ2 of the second position sensor express an angle (position) of 0˜360[°] as a unit of rotation with the rotary sensors, and have a positive value between 0˜1. For example, an example will be described below in which the load torque is 0, the reducer ratio (RM) of the reducer is 5, and the load link rotates in a direction in which the outputs of the first and second position sensors increase, where it is assumed for convenience that the zero points of θ1 and θ2 coincide. As the output of θ1 changes from 0 to 1, θ2 repeats outputting 0˜1 for 5 times. Since the multi-revolution index (TI) is calculated as a constant product of θ1 and 5 (RM), it has a value between 0˜5 in proportion to θ1. It is to be noted that, when comparing by the same rotation angle of the load and motor shaft, since TI has a resolution smaller than θ1 by multiples of RM, TI is not directly used as the position information (θM) of the motor shaft, but only integers thereof are taken and used only as the multi-revolution information of θ2. Since TI is 0˜5, integers is 0, 1, 2, 3, 4, and 5, where 5 and 0 mean the same position, that is, 5=0. Therefore, TM has values of 0, 1, 2, 3, and 4, and by using the output of θ2 as the single-revolution information, the operations of 0+0˜1, 1+0˜1, . . . , 4+0˜1 can be performed, and it is possible to calculate θM with the same resolution as θ2 in the range of 0 to 5.

In step S720, the load torque detection device calculates the strain output by the backlash and the elastic body by subtracting the single-revolution factor (TS(=TI−TM)) including the error from the second rotational position value (θ2) of the second position sensor. Specifically, the load torque detection device may calculate the strain output (θK) by the backlash and the elastic body using Equation (3) described above.

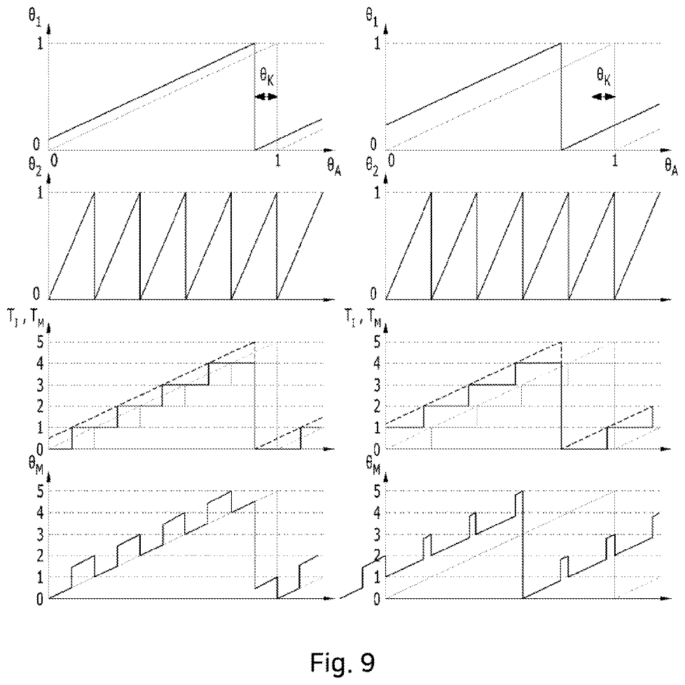

Referring to FIG. 9, an element (θK) by the backlash of the reducer and the torsion of the elastic body is taken into account in the calculation of θM. Regarding the elastic body twisted by the load torque, depending on the direction of the load torque, there may be two cases: twisting in the same direction as the rotational direction of the reducer, and twisting in the opposite direction to the rotational direction. Further, regarding the backlash, there may be two cases: in the same direction as the rotation direction of the motor, and in the opposite direction.

The strain by the backlash and the elastic body is expressed as θK, and the influence of θK on the calculation of the motor shaft position (θM) will be described. First, θK may have three cases: \textcircled{1} θK<0, \textcircled{2} θK>0, \textcircled{3} θK=0, in which case \textcircled{3} is the same as described above in FIG. 8.

In case \textcircled{1}, the first rotational position value (θ1) of the first position sensor has an output in the form of a phase delayed by θK with respect to an increase in θA, and the zero point no longer coincides with θ2.

In this state, TM changes when θ2 is at an intermediate point between 0˜1 instead of it being at the time point of changing from 1 to 0, and this means that multiple revolutions are counted before the single revolution reaches its maximum (360[°]), and θM can cause a large computational error of +1 revolution or more before θ2 exceeds its maximum output and returns to 0.

In case \textcircled{2}, conversely, θ1 has an output with a phase ahead by θK, and θM causes an error of −1 rotation or less.

For example, when θK is −0.16, and when θ2 is between 0.5 and 1, TI has a value of 0.66˜1.16. TS is 0.66˜1 and 0˜0.16. Here, the multi-revolution error occurs only when TS is 0˜0.16, and in this section, θ2 has a value of 0.84˜1, and when θK is calculated with θ2−TS, a value of 0.84 is calculated instead of −0.16. Since it is in a range beyond ±0.5, it may be determined that an operation error occurs. A value greater than 0.5 means that an operation error occurs in the state θK<0, and a value less than −0.5 means an operation error occurs in the state θK>0. As a result, it is necessary to satisfy the condition of Equation (4) and to apply −1 to the multi-revolution operation by Equations (1) and (2) to avoid calculation errors. At this time, when TI is changed to −0.66˜0.16 which is the situation before one motor revolution, when −1 is applied for TI, since the indexing value for calculating multi-revolution is negative, it has a value from 0 to less than RM.

In step S730, the load torque detection device calculates a multi-revolution value TMcomp of the motor after the compensation of the error based on the second rotational position value (θ2) of the second position sensor and the strain output (θK) by the backlash and the elastic body. Specifically, the load torque detection device may calculate the multi-revolution value (TMcomp) of the motor after the compensation of the error with Equations (4) and (5) described above.

In step S740, the load torque detection device calculates a compensated motor rotational position value (θM_{Comp}) by summing the second rotational position value (θ2) of the second position sensor and the multi-revolution factor (TM_{Comp}) after error compensation. Specifically, the load torque detection device may calculate the compensated rotational position value of the motor by using Equation (6) described above.

In step S750, the load torque detection device calculates the strain output θS by the elastic body by using the output (θ1) of the first position sensor and the reduction ratio (RM), the strain output (θB) by the backlash, and the compensated rotational position value (θMComp) of the motor. Specifically, the load torque detection device may calculate the strain output (θS) by the elastic body by using Equations (7) and (8) described above.

In step S760, the load torque detection device calculates the torque of the load link by using the strain output (θB) by the backlash, the strain output (θS) by the elastic body, and the spring coefficient. Specifically, the load torque detection device may calculate the torque (τ_{Est}) of the load link by using Equation (9) described above.

The method for detecting the load torque described above may be implemented as a computer-readable code on a computer-readable medium. The computer-readable recording medium may be a removable recording medium (CD, DVD, Blu-ray disk, USB storage device, removable hard disk) or a fixed recording medium (ROM, RAM, computer-equipped hard disk), for example. The computer program recorded on the computer-readable recording medium may be transmitted to the other computing devices through a network such as the Internet or the like and installed in the other computing devices, thereby being used in the other computing devices.

When it is described above that all components of the embodiment of the present disclosure are combined or operated as one body, the present disclosure is not necessarily limited to such an embodiment. That is, as long as it is within the scope of the present disclosure, one or more of those components may be selectively combined and operated.

Although operations are illustrated in a specific order in the drawings, it should not be understood as requiring that the operations be performed in the specific order or sequential order illustrated, or that all the illustrated operations be performed to obtain a desired result. In certain circumstances, multitasking and parallel processing may be advantageous. Moreover, separation of the various components in the embodiments described above should not be construed as necessarily requiring such separation, and it should be understood that the program components and systems described herein may generally be integrated together into a single software product or packaged into multiple software products.

The present disclosure has been mainly described above with respect to the embodiments thereof. Those of ordinary skill in the art to which the present disclosure pertains will understand that the present disclosure can be implemented in a modified form without departing from the essential characteristics of the present disclosure. Therefore, the disclosed embodiments should be considered in an illustrative rather than a restrictive sense. The scope of the present disclosure should be construed by the claims rather than the foregoing description, and all differences within the scope equivalent thereto should be construed to be included in the present disclosure.

1. A load torque detection device, comprising:
a load torque measurement actuator comprising a first position sensor, an elastic body, a reducer, a second position sensor, and a motor assembled in series to a load link, and generating information for measuring a torque of the load link by using a torsion of the elastic body; and
a load torque detection unit that indexes an output of the first position sensor connected to the load link to utilize multi-revolution information of the second position sensor connected to a shaft of the motor, and compensates for an indexing error that may occur due to the torsion of the elastic body and a backlash of the reducer to detect the torque of the load link.

2. The load torque detection device according to claim 1, wherein the first position sensor or the second position sensor is an absolute position sensor which is an optical encoder, a magnetic encoder, or a resolver.

3. The load torque detection device according to claim 1, wherein the load torque detection unit includes:
a position sensor output reception unit that receives a first rotational position value from the first position sensor positioned between the load link and the elastic body and a second rotational position value from the second position sensor positioned between the reducer and the motor;
a strain output calculation unit that calculates a strain output by the backlash and the elastic body by using the first rotational position value, the second rotational position value, and a preset reduction ratio;
a multi-revolution error compensation unit that calculates a multi-revolution value of the motor and a rotational position value of the motor which are compensated by compensating for a multi-revolution error generated by the strain by the backlash and the elastic body;
an elastic body strain output calculation unit that calculates an elastic body strain output by using the multi-revolution value of the motor and the rotational position value of the motor which are compensated by compensating for the multi-revolution error; and
a load torque calculation unit that calculates the calculated elastic body strain output, a spring coefficient, and a strain output by the backlash.

4. The load torque detection device according to claim 3, wherein the multi-revolution error compensation unit calculates the multi-revolution value of the motor and the rotational position value of the motor which are compensated by following equations (4) to (6):
TMcomp=([TI]−1)mod RM,0.5≤θK<1 and 0.5≤θ2<1 Equation (4)
TMcomp=([TI]+1)mod RM,−1≤θK<−0.5 and 0≤θ2<0.5 Equation (5)
where, TMcomp is the multi-revolution value of the motor that is error-compensated, TI is an indexing value for multi-revolution calculation, RM is a reduction ratio of the reducer, θK is the strain output by the backlash and the elastic body, and θ2 is the rotational position value of the second position sensor, and
θMcomp=TMcomp+θ2 Equation (6)
where, θMcomp is the rotational position value of the motor that is error-compensated.

5. The load torque detection device according to claim 4, wherein the elastic body strain output calculation unit calculates the elastic body strain output by following Equations (7) and (8):
θB+θS=(1+θ1)−θMcomp/RM (when TI=0 and TMcomp=RM−1) Equation (7)
θB+θS=θ1−θMcomp/RM (otherwise) Equation (8)
where, θB is the strain output by the backlash, which is an intrinsic value, θS is the strain output by the elastic body, θ1 is the rotational position value of the first position sensor, θMcomp is the rotational position value of the motor that is error-compensated, and RM is the reduction ratio of the reducer, TI is the indexing value for multi-revolution calculation, and TMcomp is the multi-revolution value of the motor that is error-compensated.

6. A load torque detection method performed by a load torque detection device, the method comprising:
calculating an indexing value for calculating a multi-revolution factor and the multi-revolution factor, by using a first rotational position value of a first position sensor and a reduction ratio;
calculating a strain output by a backlash and an elastic body by subtracting a single-revolution factor including an error from a second rotational position value of a second position sensor;
calculating a multi-revolution value of a motor that is error-compensated based on the second rotational position value of the second position sensor and the strain output by the backlash and the elastic body;
calculating a compensated rotational position value of the motor by summing the second rotational position value of the second position sensor and the multi-revolution factor that is error-compensated;
calculating the strain output by the elastic body by using the first rotational position value and the reduction ratio of the first position sensor, the strain output by the backlash, and the compensated rotational position value of the motor; and
calculating a torque of a load link by using the strain output by the backlash, the strain output by the elastic body, and a spring coefficient.

7. The load torque detection method according to claim 6, wherein the calculating a multi-revolution value of the motor that is error-compensated based on the second rotational position value of the second position sensor and the strain output by the backlash and the elastic body comprises:
calculating the multi-revolution value of the motor compensated by following Equations (4) and (5):
TMcomp=([TI]−1)mod RM,0.5≤θK<1 and 0.5≤θ2<1 Equation (4)
TMcomp=([TI]+1)mod RM,−1≤θK<−0.5 and 0≤θ2<0.5 Equation (5)
where, TMcomp is the multi-revolution value of the motor that is error-compensated, TI is an indexing value for multi-revolution calculation, RM is a reduction ratio of a reducer, θK is the strain output by the backlash and the elastic body, and θ2 is the rotational position value of the second position sensor.

8. The load torque detection method according to claim 7, wherein the calculating a compensated rotational position value of the motor by summing the second rotational position value of the second position sensor and the multi-revolution factor that is error-compensated comprises:
calculating the rotational position value of the motor compensated by following Equation (6):
θMcomp=TMcomp+θ2 Equation (6)
where, θMcomp is the rotational position value of the motor that is error-compensated, TMcomp is the multi-revolution value of the motor that is error-compensated, and θ2 is the rotational position value of the second position sensor.

9. The load torque detection method according to claim 8, wherein the calculating the strain output by the elastic body by using the first rotational position value and the reduction ratio of the first position sensor, the strain output by the backlash, and the compensated rotational position value of the motor comprises:
calculating the strain output by the elastic body by following Equations (7) and (8):
θB+θS=(1+θ1)−θMcomp/RM (when TI=0 and TMcomp=RM−1) Equation (7)
θB+θS=θ1−θMcomp/RM (otherwise) Equation (8)
where, θB is the strain output by the backlash, which is an intrinsic value, θS is the strain output by the elastic body, θ1 is the rotational position value of the first position sensor, θMcomp is the rotational position value of the motor that is error-compensated, and RM is the reduction ratio of the reducer, TI is the indexing value for multi-revolution calculation, and TMcomp is the multi-revolution value of the motor that is error-compensated.

10. A non-transitory computer-readable recording medium storing a computer program for executing the load torque detection method according to claim 6.
